(19) United States
(12) Patent Application Publication
(10) Pub. No.: US 2011/0291371 A1
(43) Pub. Date: Dec. 1, 2011

(54) Wheelbarrow

(76) Inventor: Russell William Harris, Sussex (GB)

(21) Appl. No.: 13/147,700

(22) PCT Filed: Feb. 8, 2010
(86) PCT No.: PCT/GB10/00221

§ 371 Date: Aug. 3, 2011

(30) Foreign Application Priority Data
Feb. 11, 2009 (GB) 0902223.7

(51) Int. Cl. B62B 1/18

(52) U.S. Cl. 280/47.31

(57) ABSTRACT

A wheelbarrow includes a chassis (25) having two handles (31) and legs (24), a ground-engaging rotatable member (36) carried by the chassis and a bucket (42) for loads carried by the chassis. The bucket is formed of a base panel (13), front and back panels (11) connected to the base panel, and left and right side panels (12) connected to the base panel and releasably connected to the front and rear panels. The position of the connection (22) between the side panels and the front and rear panels is adjustable, thereby to adjust the overall width of the barrow. The maximum width of the barrow in its widest configuration is greater than the maximum width of the chassis. The barrow can be reduced in width to enable it to pass through narrower entrances and can be dismantled, folded flat and suspended from a wall bracket to reduce its storage space when not in use.

### FIELD OF THE INVENTION

This invention relates to a wheelbarrow, especially a wheelbarrow intended for carrying soft garden material such as leaves, flower cuttings and compost.

### BACKGROUND TO THE INVENTION

Known wheelbarrows usually comprise a chassis having two handles and legs, a ground-engaging rotatable member such as a wheel carried by the chassis and a bucket for loads carried by the chassis. The bucket usually comprises a base panel, front and back panels connected to the base panel, and left and right side panels connected to the base panel and connected to the front and rear panels.

Collapsible wheelbarrows are known. I am aware of U.S. Pat. No. 3,722,904 (Pucket) describes a collapsible wheelbarrow adapted to having its wheel, legs and handles foldable underneath its container centre base and its container side sections foldable and enclosing about the folded wheel, legs and handles so that a substantial elongated box shape can be formed for compact safe storage and handling purposes. I am also aware of U.S. Pat. No. 6,764,093 (Allsop et al.) which describes a collapsible wheelbarrow is constructed with a pliable bin and pivotally connected handle members. The handle members are pivotally connected to a frame about first pivot axes, wherein the handle members may be moved outwardly away from an imaginary bisecting line of the wheelbarrow to provide easier loading capabilities. The handle members may also be pivotally connected about second pivot axes to allow the handle members to pivot inward to reduce the width of the wheelbarrow for convenient storage. In an alternative embodiment, the handle members are rigidly connected to the frame.

### SUMMARY OF THE INVENTION

According to the invention, there is provided a wheelbarrow comprising a chassis having two handles and legs, a ground-engaging rotatable member carried by the chassis and a bucket for loads carried by the chassis, the bucket comprising a base panel, front and back panels connected to the base panel, and left and right side panels connected to the base panel and releasably connected to the front and rear panels, the position of the connection between the side panels and the front and rear panels being adjustable, thereby to adjust the overall width of the barrow, the maximum width of the barrow in its widest configuration being greater than the maximum width of the chassis.

The base panel ideally has a polygonal shape, preferably the shape of a quadrilateral, and the side panels and the front and rear panels each ideally have a polygonal shape, preferably the shape of a trapezium.

Preferably, the position of the connection between the side panels and the front and rear panels is adjustable between a first wider configuration and a second narrower configuration. In the wider configuration the connections between the side panels and the front and rear panels are preferably formed between edges of the panels. This connection may be formed by cylindrical hinge leaf and pin type corner hinges, (referred to herein as mortice and tenon type hinges, held together with a connecting pin).

In the narrower configuration the connections between the side panels and the front and rear panels are preferably formed between edges of the side panels and connection means positioned on the inner face of the front and rear panels. Where the corner hinges are of the mortice and tenon type, the connection between the side panels and the end panels in the narrower configuration may be achieved by engaging those elements of the corner hinges with suitably positioned cooperative connection elements on the end faces.

Hinges may be positioned on the inner face of the front and rear panels enable the corner portions of the front and rear panels which lie between the connection means and the top corners of those panels to be folded into face to face relationship with the side panels. The side panels may include means for retaining the corner portions in the face to face relationship when the wheelbarrow is in its narrower configuration.

The side panels are preferably hinged to the base panel.

Similarly, the front and rear panels may be hinged to the base panel, enabling the bucket to be collapsed into a flat configuration for storage.

In a preferred embodiment, the chassis includes a portion extending forward of the ground-engaging rotatable member, which portion makes multiple point contact with the ground when the barrow is tipped up to empty the contents of the bucket, enabling the barrow to be walked forwards and backwards.

A feature of the wheelbarrow is it has pivoting handles. When the wheelbarrow is tipped up to remove the contents of the bucket the hands have to release their grip to change position to the underside of the handles. The pivoting handles allow position and grip of the hands to be maintained throughout the lifting and tipping process until the barrow is almost upright then the hands can slide down onto the leg/handle section to tip wheelbarrow further over. The spring or sprung steel strip inside the handle and shaft allows the handle to return to its original position. The pivoting handles reduce the height needed to stretch arms to get the wheelbarrow into upright position when tipping. The straight section of the chassis in front of the wheel allows the wheelbarrow to be walked back and forth while in the upright tipping position.

### INTRODUCTION TO THE DRAWINGS

An example of the invention will now be described by referring to the accompanying drawings in which:

FIG. 1 shows the bucket of a wheelbarrow according to the invention in its widest form to carry its maximum load;

FIG. 2 shows plan view of front left corner portion of the front panel of the bucket in the full width mode showing mortise protrusions;

FIG. 3 shows plan view of the nine panels that make up the bucket of the wheelbarrow;

FIG. 4 shows leg/handle sections fitted into the chassis of the wheelbarrow and how the leg/handle sections can be moved round 90° so the chassis and leg/handle section are one flat unit for storage;

FIG. 5 shows a pin that holds the bucket to chassis, the leg/handle section to the chassis and the wheel to the chassis;

FIG. 6 shows how to reduce the width of bucket;

FIG. 7 shows the bucket in reduced width mode;

FIG. 8 shows a plan view of the front left corner portion of the front panel in the reduced width mode;

FIG. 9 shows a front view of the wheelbarrow in its full width position with dotted lines to show a reduced width position;

FIG. 10 shows the chassis and leg/handle sections joined together without the bucket and the wheel;

FIG. 11 shows the handle and the shaft section;

FIG. 12 shows the wheelbarrow in various positions of use;

FIG. 13 shows wheel attached to the chassis;

FIG. 14 shows a front view of chassis and bucket, dismantled, folded and hung on wall bracket and the wheel fitted on a holding rod for storage;

FIG. 15 shows a wall bracket for holding the dismantled wheelbarrow to a wall for storage; and

FIG. 16 shows a side view of the wheelbarrow dismantled, folded and hung on wall for storage.

### DESCRIPTION OF PREFERRED EMBODIMENT

### Construction

Referring to the drawings, a wheelbarrow according to the invention includes a frame or chassis 25 having rear handles 31 and two intermediate legs 24 and supporting a single front wheel 36. The chassis 25 supports a load-carrying bucket 42 of adjustable width. The wheelbarrow is larger than a builder's wheelbarrow, so it can carry garden material that is lighter but takes up more volume than building material. The bucket has higher sides to prevent dry leaves from being blown out of the bucket in transit, due to the larger width of the bucket in its full size. As will be apparent from the following description, the barrow can be reduced in width to enable it to pass through narrower entrances. The wheelbarrow can be dismantled, folded flat and suspended from a wall bracket to reduce its storage space when not in use. The wheelbarrow is approximately 2.3 m in overall length with a 1.5 m long bucket which is 1.1 m wide in its widest configuration and 600 mm deep. The wheel 36 is approximately 30 cm wide by 50 cm diameter.

The chassis 25 is of either box channel or tubular steel or stainless steel construction made from a single length of metal bent into a “U” shape then a length of the same material welded across the middle to form an “A” shape with two leg/handle sections 29 manufactured in the same way and fixed to the “A” frame chassis with metal pins 30.

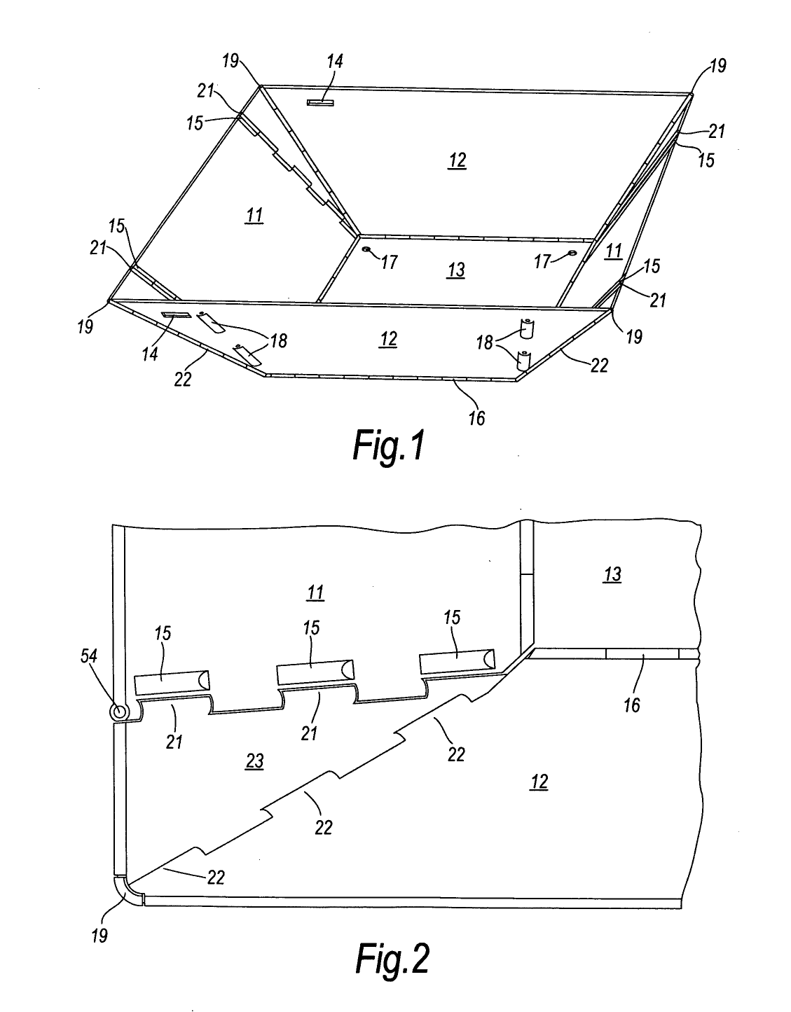

As seen particularly in FIGS. 1, 2 and 3, the bucket 42 is formed from a moulded plastic material, sheet steel or stainless steel cut and spot welded together. The bucket consists of front and rear end panels 11 of a trapezium shape, left and right trapezium shaped side panels 12 and a rectangular base panel 13. Slots 14 for storage are provided in the side panels 12 to be used as explained further below. The end panels and the side panels are hinged to the base panel 13 by base hinges 16. The base panel 13 includes holes 17 for pins that fix the bucket to the chassis.

In the full width mode of the bucket, as shown in FIG. 1, the side panels 12 are connected to the end panels 11 by mortice and tenon corner hinges 22 made up of tenon portions 20, mortice portions 51 and retaining pins 19 passing through the mortice and tenon portions to hold the hinges together.

On the outside surface of the side panels 12, towards the front and the back thereof, are protrusions 18 to receive the corner holding pins when the barrow is in its reduced width mode, as will be explained further below.

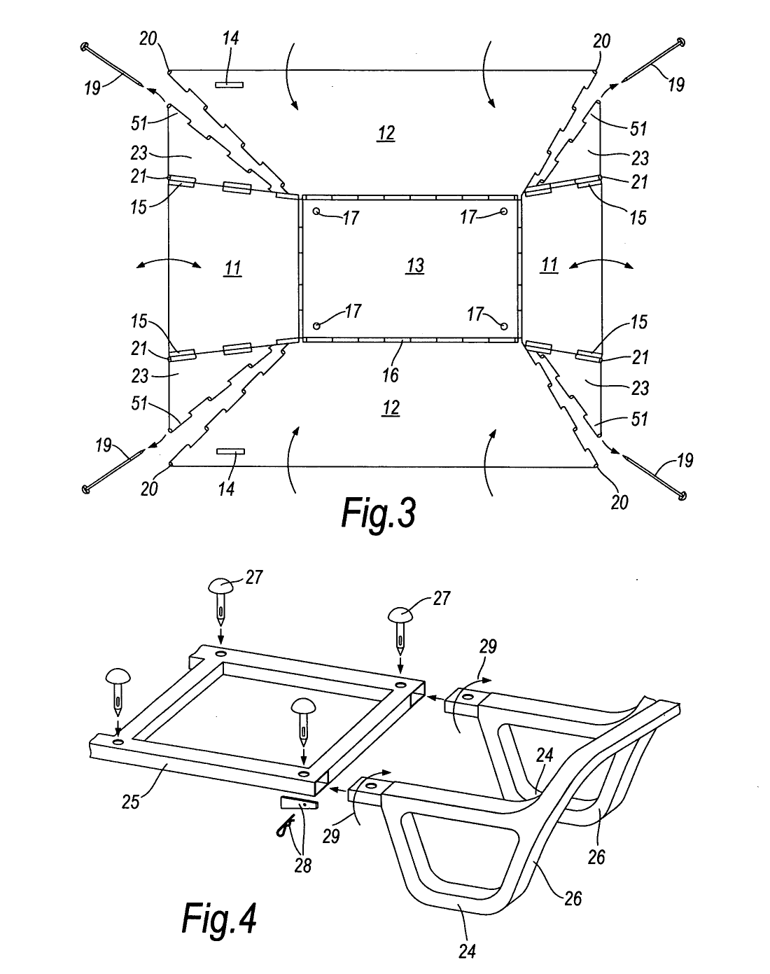

As can be seen in FIG. 3 corner portions 23 of the end panels 11 are hinged to the central portion of the end panels by intermediate mortice and tenon hinges 21 including retaining pins 54. Adjacent each intermediate hinge 21 is a line of mortice holes 15.

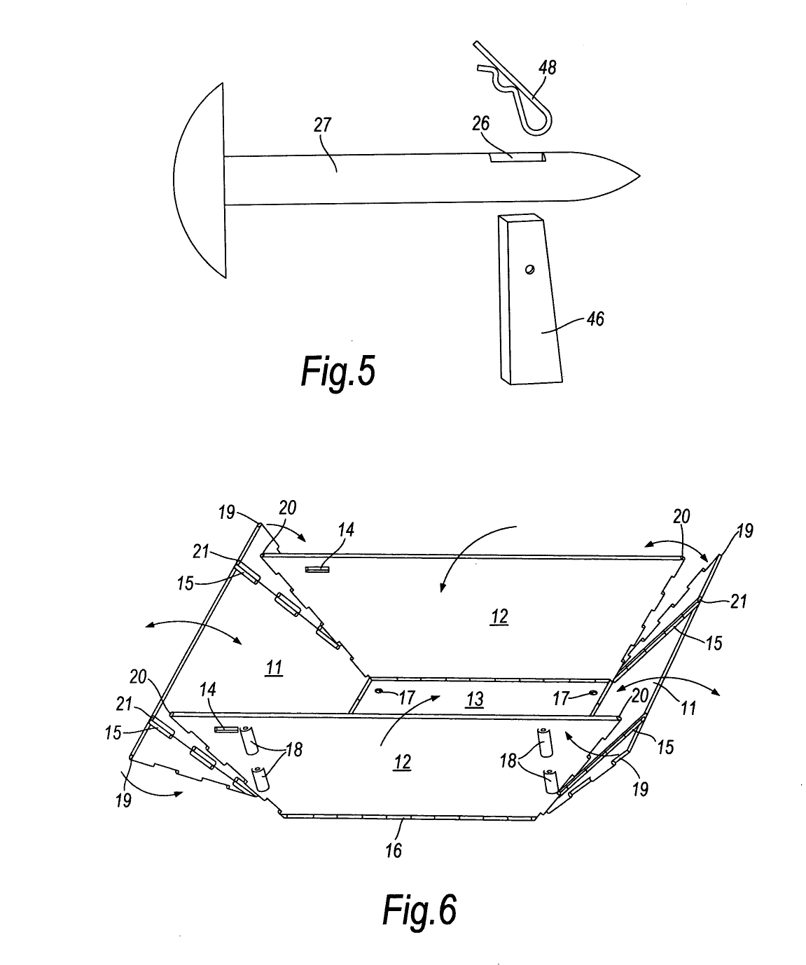

Referring now to FIGS. 4 and 5 in particular, pins 27 are shown to hold the bucket 42 to chassis and to hold the leg/handle sections 26 to the chassis 25. Each pin 27 is held securely in place by a wedge and clip 28. Referring to FIG. 5, a round headed pin 27 formed, for example, of stainless steel or steel has a slot 26 through it towards its bottom point to allow wedge 46 to go through it and be held by spring clip 48 thereby to pull sections tightly together to reduce noise, vibration and wear on parts. The pin 27 has a tapered end to aid insertion into holes.

### Adjusting the Bucket Width

Referring to FIG. 6, to reduce the bucket from full width down to reduced width, two front corner pins 19 of the front end panel 11 are removed and that end panel 11 is hinged outward to the ground. One then removes the two back corner pins 19 holding the two side panels 12 in position while the back end panel 11 is hinged outwardly enough to allow the side panels 12 to hinge inwards so that the tenon section 20 of the corner hinge 22 lines up with mortise holes 15 of the end panel 11. The end panel 11 is then hinged inwards joining side panels 12 with end panel 11. Then the corner portion 23 is hinged round so it is parallel with side panel 12. The corner holding pin 19 is then inserted into corner holding pin hole so it goes through holes in the protrusions 18 as well. The procedure is repeated for the three remaining corners.

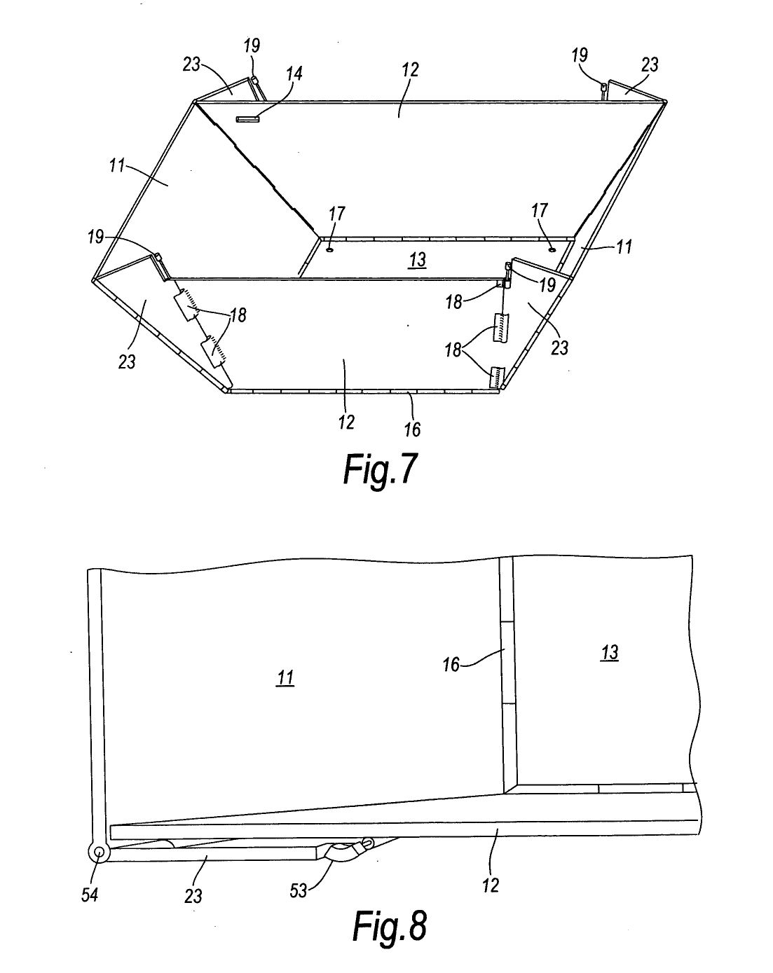

The narrower width configuration of the bucket which is thereby produced is shown in FIGS. 7 and 8. In this Figure it can be seen that the corner sections 23 of the front and rear panels 11 lie in face-to-face relationship with the side panels 12 and are held in place by the engagement of corner holding pins 19 in the aligned mortice portions 51 of the corner hinge 22 with the protrusions 18.

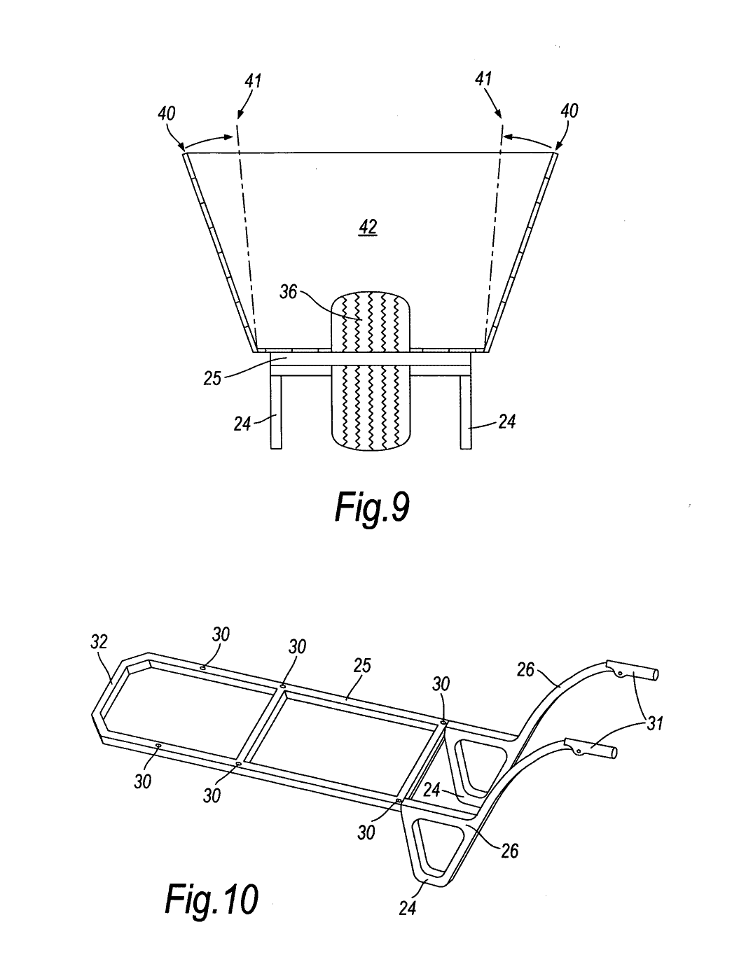

FIG. 9 shows in solid lines the full width position 40 of the bucket 42, and in broken lines the reduced width position 41.

### Using the Barrow

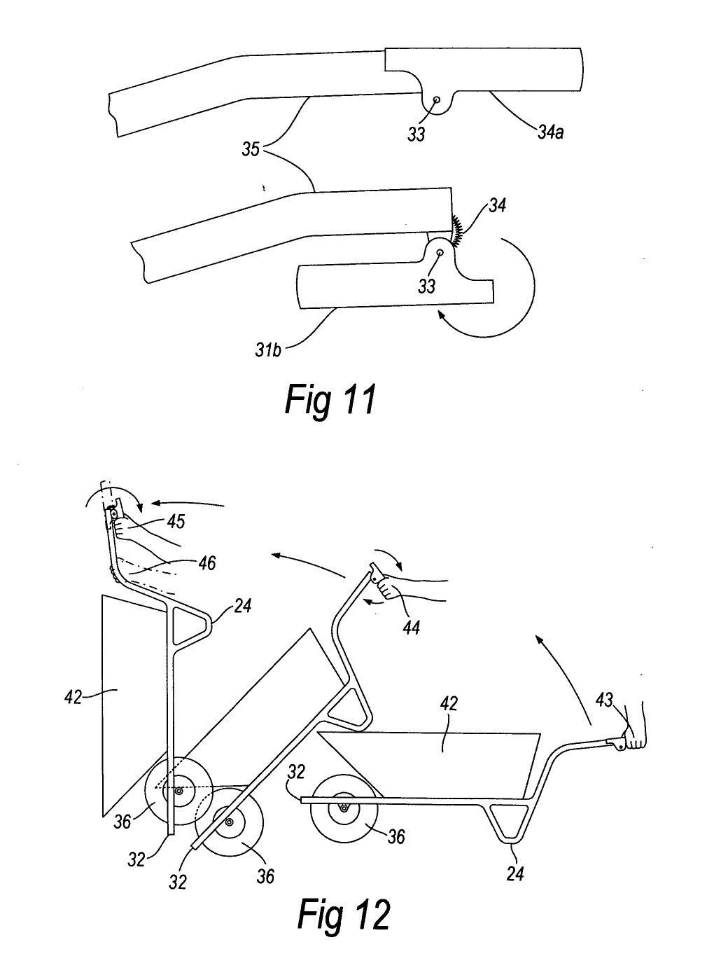

Referring to FIGS. 10 and 11 in particular, it will be seen that the chassis 25 includes two rear pivoting handles 31, each of which is mounted on a handle shaft 35 by way of a pivot pin 33 and a spring 34 to return the handle to its normal position. Thus, each handle 31 can be pivoted from a normal position 31a to a swiveled down position 31b in tipping mode of the barrow. Referring to FIG. 12, reference 43 shows the wheelbarrow in a level position on the ground. 44 shows the wheelbarrow being tipped up with the user's hand maintaining its grip on the handles. The wheelbarrow in its upright position is shown at 45 the handles being swiveled round so that grip can be maintained. Then the hands are able to slide down onto the handle shaft 35.

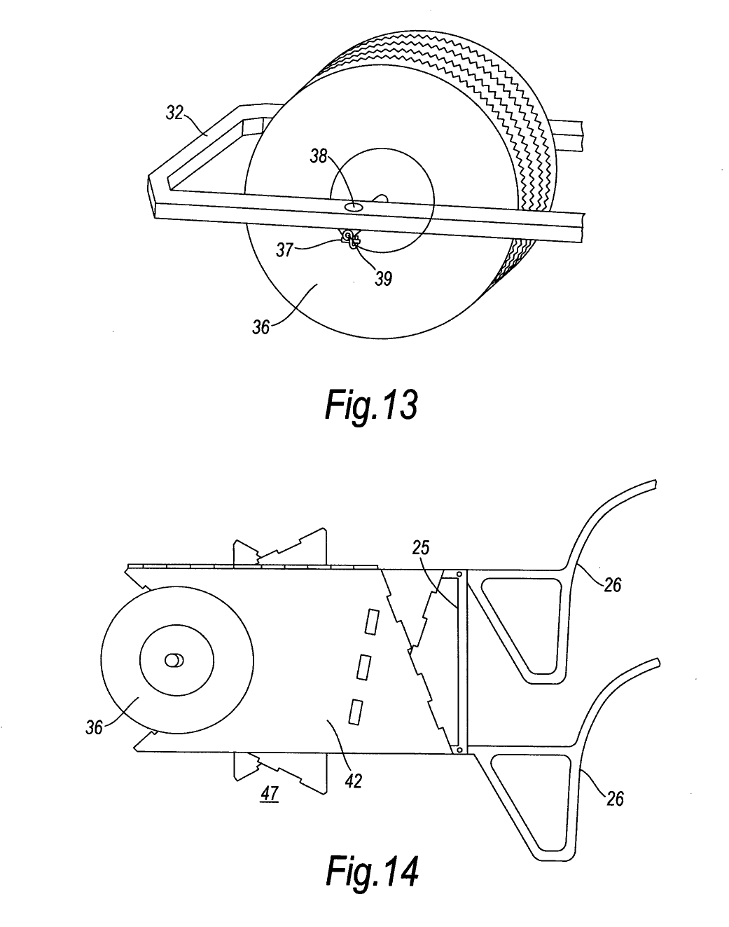

The front end of the chassis 25 includes a laterally extending straight front section 32 which makes line contact with the ground which allows the barrow to be walked back and forth while in upright tipping mode. As best seen in FIG. 13, the single wheel 36 is mounted just to the rear of the straight front section 32 on a tubular axle 39 which is held in place by a pin 38 secured by a wedge 37 and clip.

Collapsing the Barrow for Storage

Referring to FIG. 3, to fold the bucket 42 flat for storage one removes the bolts holding the bucket to the chassis, lifts the bucket off the chassis and places it on ground. The corner pins 19 are pulled out at one end to allow the end panels 11 and the side panels 12 to be lowered to the to the floor. One side panel 12 hinges over first. The other side panel then hinges onto that so they are both flat on the base panel 13. The bucket is lifted off the ground and the end panels 12 are allowed to hinge downwards to go underneath the base panel 13.

The leg/handle sections 29 pull out separately from the remainder of the chassis 25, and can be rotated through 90° and then inserted back into remaining part of the chassis so that the chassis is a flat for storage, as can be seen in FIG. 14. The pins 27 are replaced to avoid being lost during storage.

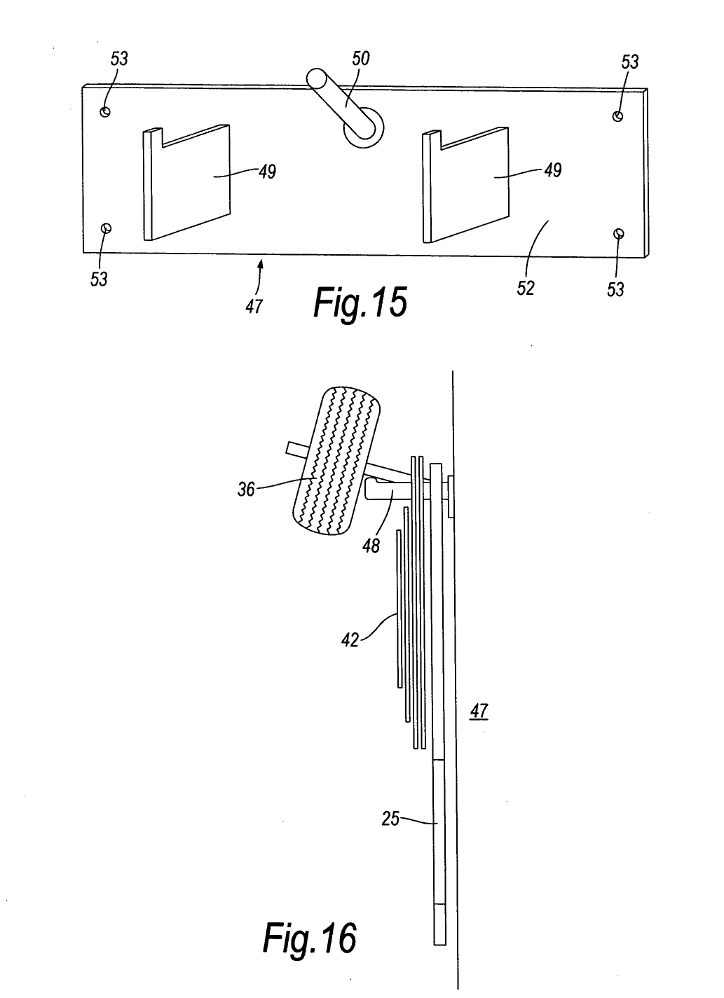

Referring to FIGS. 15 and 16, a storage bracket is formed of a sheet steel/stainless back plate 52 and two forks 49 welded to it so they are at right angles with the wall 47 when the bracket is fixed to the wall through fixing holes 53. A rod 50 of the same material is welded to the back plate 52 between the two forks and pointing at 45° to the plate. The rod is of a diameter that allows the tubular axle 39 of the wheel to slide over it. The chassis and leg/handle sections nearest the wheel end are placed around the two forks 49 so that the handle sections are nearest the ground. The bucket 42 is then placed over and in front of the chassis and the two slots 14 in FIG. 6 are placed around forks sections 49 in FIG. 15. The wheel is then fitted by putting tubular axle 39 over rod 50.

1. A wheelbarrow comprising a chassis having two handles and legs, a ground-engaging rotatable member carried by said chassis and a bucket for loads carried by said chassis, said bucket comprising a base panel, front and back panels connected to said base panel, and left and right side panels connected to said base panel and releasably connected to said front and rear panels, the position of the connection between said side panels and said front and rear panels being adjustable, thereby to adjust the overall width of the barrow, the maximum width of the barrow in its widest configuration being greater than the maximum width of said chassis.

2. A wheelbarrow according to claim 1, wherein said base panel has a polygonal shape, and wherein said side panels and said front and rear panels each have a polygonal shape.

3. A wheelbarrow according to claim 1, wherein the position of the connection between said side panels and said front and rear panels is adjustable between said widest configuration and a second narrower configuration.

4. A wheelbarrow according to claim 3, wherein in said wider configuration the connections between said side panels and said front and rear panels are formed between edges of said panels.

5. A wheelbarrow according to claim 3, wherein in said narrower configuration the connections between said side panels and said front and rear panels are formed between edges of said side panels and connection means positioned on an inner face of said front and rear panels.

6. A wheelbarrow according to claim 5, wherein hinges positioned on said inner face of said front and rear panels enable corner portions of said front and rear panels which lie between said connection means and the corners of those panels to be folded into face to face relationship with said side panels.

7. A wheelbarrow according to claim 6, wherein said side panels include means for retaining said corner portions in said face to face relationship when the wheelbarrow is in said narrower configuration.

8. A wheelbarrow according to claim 1, wherein said side panels are hinged to said base panel.

9. A wheelbarrow according to claim 1, wherein said front and rear panels are hinged to said base panel, enabling said bucket to be collapsed into a flat configuration for storage.

10. A wheelbarrow according to claim 1, wherein said chassis includes a portion extending forward of said ground-engaging rotatable member, which portion makes multiple point contact with the ground when the barrow is tipped up to empty the contents of said bucket, enabling the barrow to be walked forwards and backwards.
